(19) United States
(12) Patent Application Publication
(10) Pub. No.: US 2024/0301139 A1
(43) Pub. Date: Sep. 12, 2024

(54) MATERIAL FOR MELT PROCESSING AND MELT-PROCESSED PRODUCT

(71) Applicant: HONSHU CHEMICAL INDUSTRY CO., LTD., Chuo-ku, Tokyo (JP)

(72) Inventors: Ryota IMAI, Wakayama-shi (JP); Kazuhisa YAJIMA, Wakayama-shi (JP)

(21) Appl. No.: 18/560,816

(22) PCT Filed: Apr. 19, 2022
(86) PCT No.: PCT/JP2022/018148

§ 371 Date: Nov. 14, 2023

(30) Foreign Application Priority Data
May 21, 2021 (JP) 2021-085740

(51) Int. Cl. C08G 73/10

(52) U.S. Cl. CPC C08G 73/1064

(57) ABSTRACT

A material for melt processing contains a polyimide having a repeating unit represented by general formula (1) below.

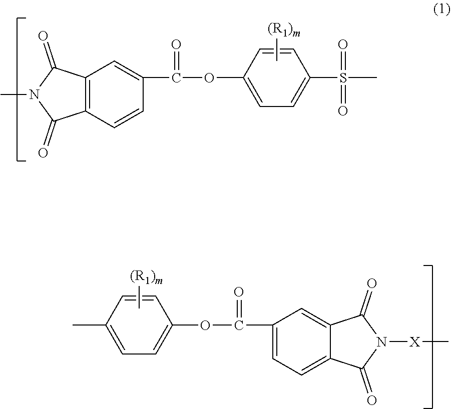

wherein each R₁ independently represents a linear or branched alkyl group having 1 to 6 carbon atoms, a linear or branched alkyl halide group having 1 to 6 carbon atoms, or a halogen atom, each m independently represents 0, 1, or 2, and X represents a divalent chemical group represented by general formula (2) below,

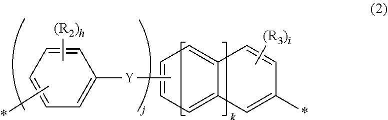

wherein the polyimide is made to have high heat resistance and high melt flowability.

### TECHNICAL FIELD

The present invention relates to a material for melt processing containing a polyimide having a structure derived from a trimellitic anhydride ester of a bis (4-hydroxyphenyl) sulfone and a particular diamine and to melt-processed products obtained by performing melt processing using the material, such as films, lenses, tapes, various electronic materials such as laminates and flexible printed circuits (FPCs), and three-dimensional objects.

### BACKGROUND ART

In general, polyimides are materials that are characterized by having high heat resistance and that on the other hand are insoluble and infusible. Thus, when a polyimide is used as a molding material, it is necessary to use a special technique such as sinter molding, and in addition, to obtain a processed product having a complicated shape by sinter molding, a complicated and complex processing step, such as cutting out a desired shape from a polyimide block by using a cutting machine such as an NC lathe, is required, as a result of which the processed product is disadvantageously costly.

Although some of the polyimides have thermoplasticity (e.g., PTL 1), when a polyimide resin having a high glass transition temperature is used for the purpose of, for example, obtaining a polyimide film having high heat resistance, the higher the heat resistance, the poorer the flowability, which is disadvantageous in processing.

### CITATION LIST

### Patent Literature

PTL 1: Japanese Unexamined Patent Application Publication No. 09-048851

### SUMMARY OF INVENTION

### Technical Problem

An object of the present invention is to provide a polyimide having both high heat resistance and high melt flowability and a material for melt processing containing the polyimide and having high heat resistance and high melt processability.

### Solution to Problem

To achieve the above object, the present inventors have conducted intensive studies and found that a polyimide having a structure derived from a trimellitic anhydride ester of a bis (4-hydroxyphenyl) sulfone and a particular diamine has thermoplasticity and is useful as a material that can be subjected to melt processing, thereby completing the present invention. The inventors have further found that the polyimide has high heat resistance and is also excellent in melt flowability, which is in a trade-off relationship with the high heat resistance, and thus can be used as a material having both high heat resistance and high melt processability.

The present invention is as follows.

1. A material for melt processing, containing a polyimide having a repeating unit represented by general formula (1) below

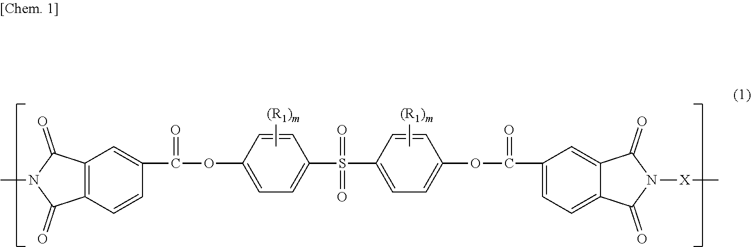

(In the formula, each R₁ independently represents a linear or branched alkyl group having 1 to 6 carbon atoms, a linear or branched alkyl halide group having 1 to 6 carbon atoms, or a halogen atom, each m independently represents 0, 1, or 2, and X represents a divalent chemical group represented by general formula (2) below.)

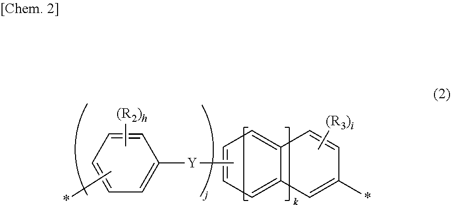

(In the formula, R₂ and R₃ each independently represent a linear or branched alkyl group having 1 to 6 carbon atoms, a linear or branched alkyl halide group having 1 to 6 carbon atoms, or a halogen atom, Y represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylmethylidene group, a phenylethylidene group, a phenylene group, or a fluorenylidene group, j represents 0 or 1, h and i each independently represent 0, 1, or 2, k represents 0, 1, or 2, and each * represents a position of bonding to a nitrogen atom in general formula (1).) 2. A melt-processed product obtained by performing melt processing using the material for melt processing according to 1.

### Advantageous Effects of Invention

The polyimide having a structure derived from a trimellitic anhydride ester of a bis (4-hydroxyphenyl) sulfone and a particular diamine according to the present invention has thermoplasticity, and thus can be subjected to melt processing and can be used as a material for melt processing. Furthermore, the polyimide, compared with a polyimide conventionally known to have thermoplasticity and having a structure derived from a trimellitic anhydride ester of a bis (4-hydroxyphenyl) sulfone, has high heat resistance and, in addition, high melt flowability, which is in a trade-off relationship with the high heat resistance, and thus the material containing the polyimide exhibits a remarkable effect, that is, high heat resistance and high melt processability. The material for melt processing according to the present invention is suitable for use as a material for polyimide-containing melt-processed products such as films, lenses, tapes, various electrical and electronic components such as laminates (e.g., copper-clad laminates) and flexible printed circuits (FPCs), sealants for electronic components, automotive parts, laminated materials, adhesives, prepregs, and three-dimensional objects.

### BRIEF DESCRIPTION OF DRAWINGS

FIG. 1 is a graph showing a storage modulus curve of a polyimide obtained in Example 1.

FIG. 2 is a graph showing a loss modulus curve of the polyimide obtained in Example 1.

FIG. 3 is a graph showing a TMA curve of the polyimide obtained in Example 1.

FIG. 4 is a graph showing a storage modulus curve of a polyimide obtained in Comparative Example 1.

FIG. 5 is a graph showing a loss modulus curve of the polyimide obtained in Comparative Example 1.

FIG. 6 is a graph showing a TMA curve of the polyimide obtained in Comparative Example 1.

FIG. 7 is a graph showing a TMA curve of a polyimide obtained in Example 2.

FIG. 8 is a graph showing a TMA curve of a polyimide obtained in Example 3.

FIG. 9 is a graph showing a TMA curve of a polyimide obtained in Example 4.

FIG. 10 is a graph showing a TMA curve of a polyimide obtained in Example 5.

FIG. 11 is a graph showing a storage modulus curve of a polyimide obtained in Comparative Example 2.

FIG. 12 is a graph showing a loss modulus curve of the polyimide obtained in Comparative Example 2.

FIG. 13 is a graph showing a TMA curve of the polyimide obtained in Comparative Example 2.

FIG. 14 is a graph showing a TMA curve of a polyimide obtained in Comparative Example 3.

### DESCRIPTION OF EMBODIMENTS

A material for melt processing according to the present invention contains a polyimide having a repeating unit represented by general formula (1) above.

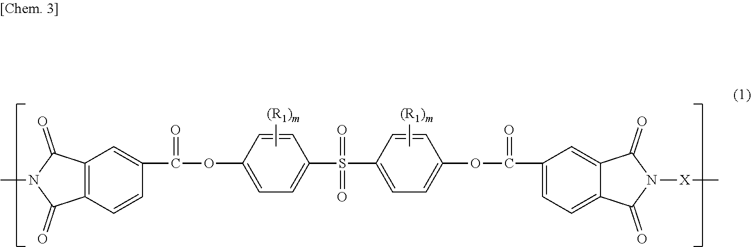

(In the formula, each R₁ independently represents a linear or branched alkyl group having 1 to 6 carbon atoms, a linear or branched alkyl halide group having 1 to 6 carbon atoms, or a halogen atom, each m independently represents 0, 1, or 2, and X represents a divalent chemical group represented by general formula (2) below.)

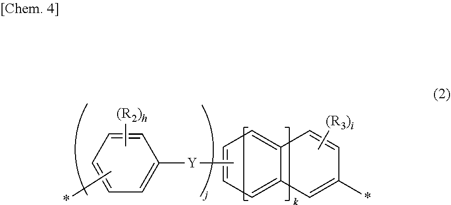

(In the formula, R₂ and R₃ each independently represent a linear or branched alkyl group having 1 to 6 carbon atoms, a linear or branched alkyl halide group having 1 to 6 carbon atoms, or a halogen atom, Y represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylmethylidene group, a phenylethylidene group, a phenylene group, or a fluorenylidene group, j represents 0 or 1, h and i each independently represent 0, 1, or 2, k represents 0, 1, or 2, and each * represents a position of bonding to a nitrogen atom in general formula (1).)

Each R₁ in general formula (1) above independently represents a linear or branched alkyl group having 1 to 6 carbon atoms, a linear or branched alkyl halide group having 1 to 6 carbon atoms, or a halogen atom, preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, particularly preferably a trifluoromethyl group or a fluorine atom.

The position of substitution of each R₁ is preferably the ortho position relative to the oxygen atom.

Each m in general formula (1) above independently represents 0, 1, or 2, preferably 0 or 1, particularly preferably 0.

R₂ and R₃ in general formula (2) above each independently represent a linear or branched alkyl group having 1 to 6 carbon atoms, a linear or branched alkyl halide group having 1 to 6 carbon atoms, or a halogen atom, preferably a linear or branched alkyl group having 1 to 4 carbon atoms, a linear or branched alkyl halide group having 1 to 4 carbon atoms, or a halogen atom, more preferably a linear or branched alkyl halide group having 1 to 4 carbon atoms or a halogen atom, particularly preferably a trifluoromethyl group or a fluorine atom.

Y in general formula (2) represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylmethylidene group, a phenylethylidene group, a phenylene group, or a fluorenylidene group, preferably a direct bond, an oxygen atom, a sulfur atom, a sulfonyl group (—SO₂—), a carbonyl group (—CO—), an amide group (—NHCO—), an ester group (—OCO—), an alkylidene group having 1 to 12 carbon atoms, a fluorine-containing alkylidene group having 2 to 12 carbon atoms, a cycloalkylidene group having 5 to 12 carbon atoms, a phenylethylidene group, or a fluorenylidene group, more preferably a direct bond, an oxygen atom, a sulfur atom, a sulfonyl group (—SO₂—), a carbonyl group (—CO—), an amide group (—NHCO—), an ester group (—OCO—), an alkylidene group having 1 to 8 carbon atoms, a fluorine-containing alkylidene group having 2 to 8 carbon atoms, a cycloalkylidene group having 6 to 12 carbon atoms, a phenylethylidene group, or a fluorenylidene group, particularly preferably a direct bond, an oxygen atom, a sulfur atom, a sulfonyl group (—SO₂—), an amide group (—NHCO—), an ester group (—OCO—), an alkylidene group having 1 to 4 carbon atoms, a fluorine-containing alkylidene group having 2 to 4 carbon atoms, a cycloalkylidene group having 6 to 9 carbon atoms, or a fluorenylidene group.

The cycloalkylidene group having 5 to 15 carbon atoms may include a branched-chain alkyl group. Specific examples of the cycloalkylidene group include a cyclopentylidene group (5 carbon atoms), a cyclohexylidene group (6 carbon atoms), a 3-methylcyclohexylidene group (7 carbon atoms), a 4-methylcyclohexylidene group (7 carbon atoms), a 3,3,5-trimethylcyclohexylidene group (9 carbon atoms), a cycloheptylidene group (7 carbon atoms), and a cyclododecanylidene group (12 carbon atoms).

In general formula (2), j represents 0 or 1, preferably 1. h and i each independently represent 0, 1, or 2, preferably 0 or 1. k represents 0, 1, or 2, preferably 0 or 1, more preferably 0.

Preferred examples of the divalent chemical group represented by general formula (2) in the present invention include formulae (i) to (x) shown below.

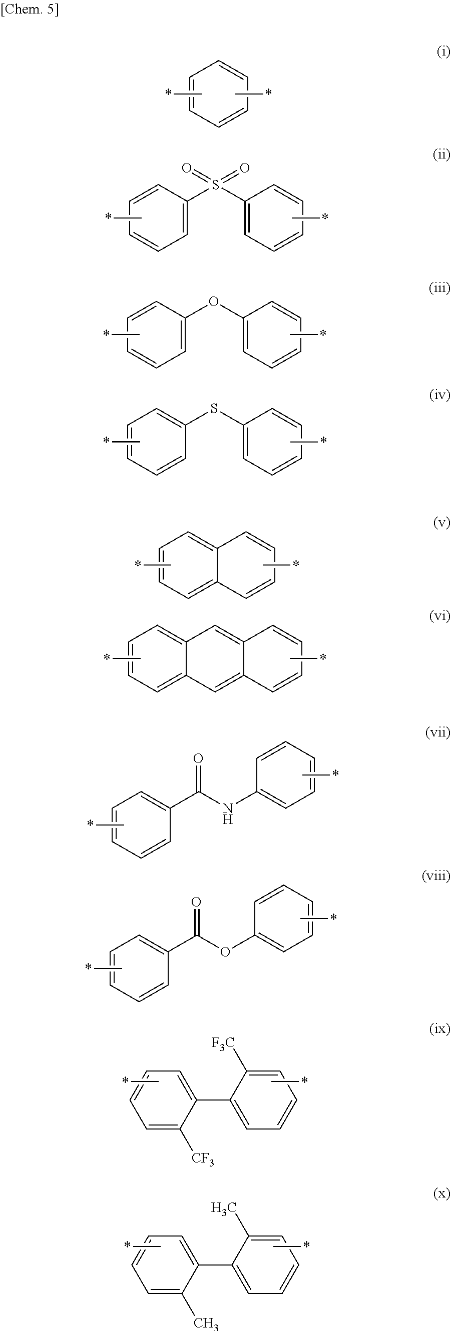

Of these, the chemical groups of formulae (i) to (iii), (ix), and (x) are preferred, the chemical groups of formulae (i), (ii), and (ix) are more preferred, and the chemical groups of formulae (ii) and (ix) are particularly preferred.

Specific examples of diamine compounds having structures of the above preferred divalent chemical groups represented by general formula (2) include m-phenylenediamine, p-phenylenediamine, 4,4′-diaminodiphenylsulfone, 3,3′-diaminodiphenylsulfone, 4,4′-diaminodiphenyl ether, 3,4′-diaminodiphenyl ether, 3,3′-diaminodiphenyl ether, 4,4′-diaminodiphenyl sulfide, 3,4′-diaminodiphenyl sulfide, 3,3′-diaminodiphenyl sulfide, 1,5-diaminonaphthalene, 2,6-diaminonaphthalene, 2,7-diaminonaphthalene, 2,6-diaminoanthracene, 2,7-diaminoanthracene, 1,8-diaminoanthracene, 1,5-diaminoanthracene, 4,4′-diaminobenzanilide, 3-amino-N-(4-aminophenyl)-benzamide, 4-amino-N-(3-aminophenyl)-benzamide, 4-aminophenyl-4-aminobenzoate, 3-aminophenyl-4-aminobenzoate, 4-aminophenyl-3-aminobenzoate, 2,2′-bis (trifluoromethyl) benzidine, and 2,2′-dimethylbenzidine.

Of these, m-phenylenediamine, p-phenylenediamine, 4,4′-diaminodiphenylsulfone, 3,3′-diaminodiphenylsulfone, 4,4′-diaminodiphenyl ether, 3,4′-diaminodiphenyl ether, 3,3′-diaminodiphenyl ether, 4,4′-diaminodiphenyl sulfide, 2,6-diaminonaphthalene, 2,7-diaminonaphthalene, 4,4′-diaminobenzanilide, 4-aminophenyl-4-aminobenzoate, 2,2′-bis (trifluoromethyl) benzidine, and 2,2′-dimethylbenzidine are preferred, m-phenylenediamine, p-phenylenediamine, 4,4′-diaminodiphenylsulfone, 3,3′-diaminodiphenylsulfone, 4,4′-diaminodiphenyl ether, 3,4′-diaminodiphenyl ether, 3,3′-diaminodiphenyl ether, 2,2′-bis (trifluoromethyl) benzidine, and 2,2′-dimethylbenzidine are more preferred, m-phenylenediamine, p-phenylenediamine, 4,4′-diaminodiphenylsulfone, 3,3′-diaminodiphenylsulfone, 4,4′-diaminodiphenyl ether, and 2,2′-bis (trifluoromethyl) benzidine are still more preferred, and 4,4′-diaminodiphenylsulfone, 3,3′-diaminodiphenylsulfone, and 2, 2′-bis (trifluoromethyl) benzidine are particularly preferred.

The method for producing the polyimide contained in the material for melt processing according to the present invention is not particularly limited. For example, the polyimide can be produced through a step of reacting a tetracarboxylic dianhydride represented by general formula (3) below and a diamine compound having a structure represented by general formula (2) above such that the amounts of the substances are equimolar to obtain a polyimide precursor (polyamic acid) and a step of imidizing the polyimide precursor.

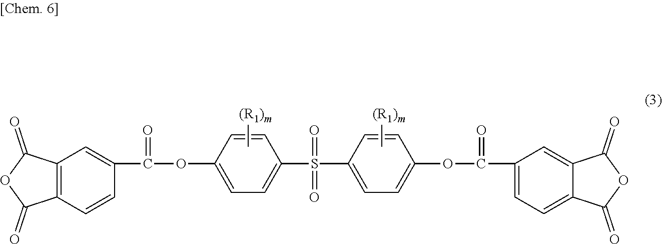

(In the formula, R₁ and m are the same as those in general formula (1).)

As a specific example of the method, a production method in the case where the tetracarboxylic dianhydride represented by general formula (3) above is 4,4′-dihydroxydiphenylsulfone-bis (trimellitate anhydride) (a) and the divalent chemical group represented by general formula (2) above is 4,4′-diaminodiphenylsulfone (b), which is a chemical group of formula (ii) above, is shown by the following reaction formula. The compound (a) and the compound (b) are polymerized to obtain a polyimide precursor (polyamic acid) (c) having the following repeating unit, and the polyimide precursor (c) is imidized, whereby a target polyimide (d) having the following repeating unit can be obtained.

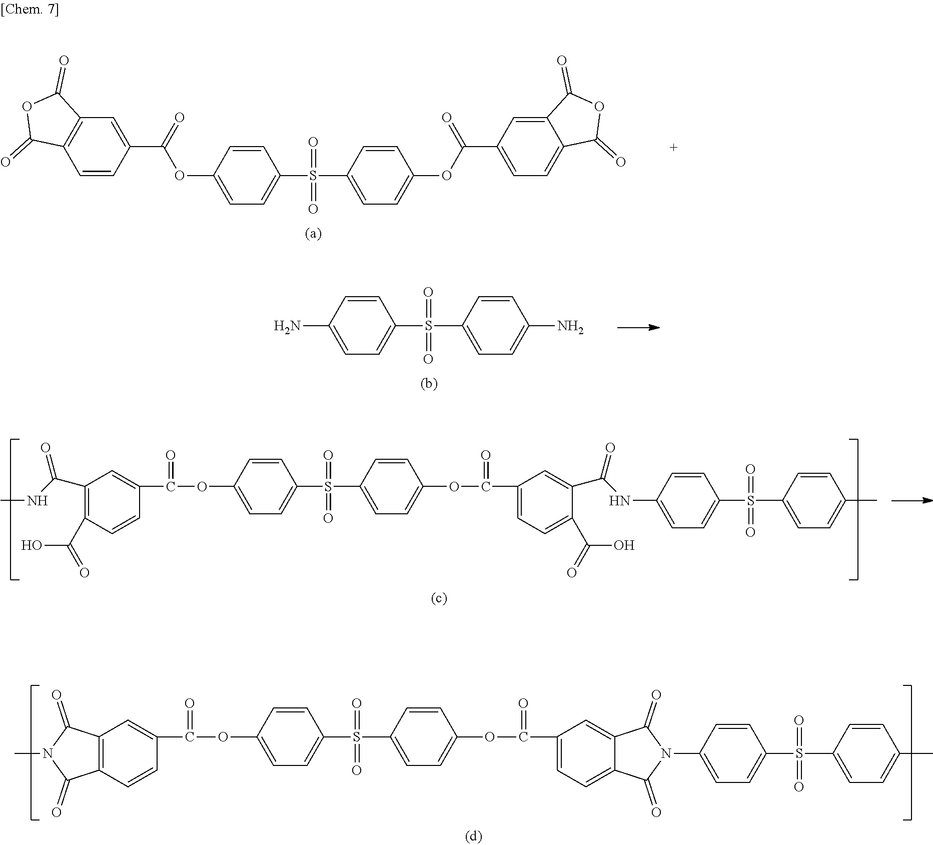

For the tetracarboxylic dianhydride represented by general formula (3) above, R₁ and m are the same as those in general formula (1), and preferred modes thereof are also the same. Specific examples of the tetracarboxylic dianhydride represented by general formula (3) include 4,4′-dihydroxydiphenylsulfone-bis (trimellitate anhydride), 4,4′-dihydroxy-3,3′-dimethyldiphenylsulfone-bis (trimellitate anhydride), 4,4′-dihydroxy-3,3′, 5,5′-tetramethyldiphenylsulfone-bis (trimellitate anhydride), 4,4′-dihydroxy-3,3′-bis (trifluoromethyl) diphenylsulfone-bis (trimellitate anhydride), 4,4′-dihydroxy-3, 3′, 5, 5′-tetrakis (trifluoromethyl) diphenylsulfone-bis (trimellitate anhydride), 4,4′-dihydroxy-3,3′-difluorodiphenylsulfone-bis (trimellitate anhydride), 4,4′-dihydroxy-3,3′, 5,5′-tetrafluorodiphenylsulfone-bis (trimellitate anhydride), 4,4′-dihydroxy-3,3′-dichlorodiphenylsulfone-bis (trimellitate anhydride), 4,4′-dihydroxy-3,3′, 5,5′-tetrachlorodiphenylsulfone-bis (trimellitate anhydride), 4,4′-dihydroxy-3,3′-dibromodiphenylsulfone-bis (trimellitate anhydride), and 4,4′-dihydroxy-3,3′, 5,5′-tetrabromodiphenylsulfone-bis (trimellitate anhydride). Of these, 4,4′-dihydroxydiphenylsulfone-bis (trimellitate anhydride), 4,4′-dihydroxy-3,3′-dimethyldiphenylsulfone-bis (trimellitate anhydride), 4,4′-dihydroxy-3,3,5,5′-tetramethyldiphenylsulfone-bis (trimellitate anhydride), 4,4′-dihydroxy-3,3′-bis (trifluoromethyl) diphenylsulfone-bis (trimellitate anhydride), and 4,4′-dihydroxy-3, 3′, 5, 5′-tetrakis (trifluoromethyl) diphenylsulfone-bis (trimellitate anhydride) are preferred, and 4,4′-dihydroxydiphenylsulfone-bis (trimellitate anhydride) is particularly preferred.

The polyimide contained in the material for melt processing according to the present invention, if containing the repeating unit represented by general formula (1) above, may have another skeleton without impairing the advantageous effects of the present invention. For example, a tetracarboxylic dianhydride and a diamine that form a skeleton other than the skeleton represented by general formula (1) above can be used. In this case, the repeating unit of the polyimide according to the present invention represented by general formula (1) above is contained in an amount of preferably 50 mol % or more, more preferably 60 mol % or more, still more preferably 70 mol % or more, particularly preferably 90 mol % or more, relative to the total amount of the polyimide. The repeating unit of general formula (1) above may be regularly arranged or randomly present in the polyimide.

The method for producing the polyimide contained in the material for melt processing according to the present invention is not particularly limited, and a known method can be appropriately applied. Specifically, for example, the polyimide can be synthesized by the following method.

First, a diamine compound is dissolved in a polymerization solvent, and powder of a tetracarboxylic dianhydride substantially equimolar to the diamine compound is slowly added to the solution. Using a mechanical stirrer or the like, the resulting solution is stirred at a temperature in the range of 0° C. to 100° C., preferably in the range of 20° C. to 60° C., for 0.5 to 150 hours, preferably 1 to 72 hours. At this time, the monomer concentration is typically in the range of 5 to 50 wt %, preferably in the range of 10 to 40 wt %. By performing polymerization in such a monomer concentration range, a uniform and highly polymerized polyimide precursor (polyamic acid) can be obtained. If the degree of polymerization of the polyimide precursor (polyamic acid) is excessively increased to make it difficult to stir the polymer solution, the polymer solution may be appropriately diluted with the same solvent. By performing polymerization in the above monomer concentration range, the degree of polymerization of the polymer can be sufficiently high, and the solubility of the monomers and the polymer can be sufficiently secured. If the polymerization is performed at a concentration lower than the above range, the degree of polymerization of the polyimide precursor (polyamic acid) may not be sufficiently high, and if the polymerization is performed at a concentration higher than the above monomer concentration range, the dissolution of the monomers and the resulting polymer may be insufficient.

The solvent used for the polymerization of the polyimide precursor (polyamic acid) is preferably an aprotic solvent such as N, N-dimethylformamide, N, N-dimethylacetamide, N-methyl-2-pyrrolidone, or dimethylsulfoxide, but any solvent in which the starting monomers, the resulting polyimide precursor (polyamic acid), and an imidized polyimide are soluble can be used without any problem, and the structure and type of the solvent are not particularly limited. Specific examples include amide solvents such as N, N-dimethylformamide, N, N-dimethylacetamide, and N-methyl-2-pyrrolidone; ester solvents such as γ-butyrolactone, γ-valerolactone, δ-valerolactone, γ-caprolactone, ε-caprolactone, α-methyl-γ-butyrolactone, butyl acetate, ethyl acetate, and isobutyl acetate; carbonate solvents such as ethylene carbonate and propylene carbonate; glycol solvents such as diethylene glycol dimethyl ether, triethylene glycol, and triethylene glycol dimethyl ether; phenolic solvents such as phenol, m-cresol, p-cresol, o-cresol, 3-chlorophenol, and 4-chlorophenol; ketone solvents such as cyclopentanone, cyclohexanone, acetone, methyl ethyl ketone, diisobutyl ketone, and methyl isobutyl ketone; and ether solvents such as tetrahydrofuran, 1,4-dioxane, dimethoxyethane, diethoxyethane, and dibutyl ether. Other general-purpose solvents that can be used include acetophenone, 1,3-dimethyl-2-imidazolidinone, sulfolane, dimethylsulfoxide, propylene glycol methyl acetate, ethyl cellosolve, butyl cellosolve, 2-methyl cellosolve acetate, ethyl cellosolve acetate, butyl cellosolve acetate, butanol, ethanol, xylene, toluene, chlorobenzene, turpentine, mineral spirits, and petroleum naphtha solvents. These solvents may be used as a mixture of two or more.

A method for imidizing the polyimide precursor (polyamic acid) obtained will be described.

For imidization, a known imidization method can be applied. For example, a “thermal imidization method” in which a polyimide precursor (polyamic acid) film is thermally cyclized, a “solution thermal imidization method” in which a polyimide precursor (polyamic acid) solution is cyclized at a high temperature, a “chemical imidization method” in which a dehydrator is used, or the like can be appropriately used.

Specifically, in the “thermal imidization method”, the polyimide precursor (polyamic acid) solution is cast on a substrate or the like and dried at 50° C. to 200° C., preferably 60° C. to 150° C., to form a polyimide precursor (polyamic acid) film, which is then heated in an inert gas or under reduced pressure at 150° C. to 400° C., preferably 200° C. to 380° C., for 1 to 12 hours to cause thermal dehydration cyclization and complete imidization, whereby the polyimide contained in the material for melt processing according to the present invention can be obtained. Also, in this manner, the material for melt processing according to the present invention in the form of a film can be obtained.

In the “solution thermal imidization method”, the polyimide precursor (polyamic acid) solution to which a basic catalyst or the like has been added is heated in the presence of an azeotropic agent such as xylene at 100° C. to 250° C., preferably 150° C. to 220° C., for 0.5 to 12 hours to remove water produced as a by-product out of the system and complete imidization, whereby the polyimide solution contained in the material for melt processing according to the present invention can be obtained.

In the “chemical imidization method”, while the polyimide precursor (polyamic acid) solution adjusted to have an appropriate solution viscosity that allows the polyimide precursor (polyamic acid) to be easily stirred is stirred with a mechanical stirrer or the like, a dehydration cyclizing agent (chemical imidizing agent) composed of an organic acid anhydride and an amine as a basic catalyst is added dropwise, and stirring is performed at 0° C. to 100° C., preferably 10° C. to 50° C., for 1 to 72 hours to chemically complete imidization. Examples of the organic acid anhydride usable here include, but are not limited to, acetic anhydride and propionic anhydride. In terms of the ease of handling and purification of a reagent, acetic anhydride is suitable for use. As the basic catalyst, pyridine, triethylamine, quinoline, or the like can be used, and in terms of the ease of handling and separation of a reagent, pyridine is suitable for use, but the basic catalyst is not limited thereto. The amount of the organic acid anhydride in the chemical imidizing agent is in the range of 1 to 10 times, more preferably in the range of 1 to 5 times, the theoretical dehydration amount of the polyimide precursor (polyamic acid) on a molar basis. The amount of the basic catalyst is in the range of 0.1 to 2 times, more preferably in the range of 0.1 to 1 times, the amount of the organic acid anhydride on a molar basis.

In the “solution thermal imidization method” or the “chemical imidization method”, the reaction solution contains the catalyst, the chemical imidizing agent, and by-products such as carboxylic acids (hereinafter referred to as impurities) and thus may be purified by removal thereof. For the purification, a known method can be used. For example, one of the most convenient methods is a method in which the reaction solution subjected to imidization is added dropwise into a large amount of poor solvent with stirring to precipitate the polyimide, and then the polyimide powder is recovered and repeatedly washed until the impurities are removed. Solvents suitable for use here are water and alcohols such as methanol, ethanol, and isopropanol, which cause the polyimide to precipitate, allow the impurities to be efficiently removed, and are readily dried, and these may be used as a mixture. If the concentration of the polyimide solution added dropwise into the poor solvent to cause precipitation is excessively high, the polyimide precipitated becomes a granular mass, so that the impurities may remain in the coarse particles, or it may take a long time to dissolve the obtained polyimide powder in the solvent. On the other hand, if the concentration of the polyimide solution is excessively low, a great amount of poor solvent is required, which is not preferred because disposal of waste solvent leads to an increased environmental load and a higher production cost. Therefore, the concentration of the polyimide solution added dropwise into the poor solvent is 20 wt % or less, more preferably 10 wt % or less. The amount of the poor solvent used here is preferably equal to or more than, suitably 1.5 to 3 times, the amount of the polyimide solution.

The polyimide powder obtained is recovered, and residual solvent is removed by, for example, vacuum drying or hot-air drying, whereby the polyimide contained in the material for melt processing according to the present invention can be obtained. Also, in this manner, the resin material for melt processing according to the present invention in the form of powder can be obtained. The temperature and time of drying are not limited as long as the polyimide does not degrade or the residual solvent does not decompose at the temperature, and drying in a temperature range of 30° C. to 200° C. for 48 hours or less is preferred.

The intrinsic viscosity of the polyimide contained in the material for melt processing according to the present invention is preferably in the range of 0.1 to 10.0 dL/g, more preferably in the range of 0.2 to 5.0 dL/g.

The polyimide contained in the material for melt processing according to the present invention is soluble in various organic solvents and thus can be formed into polyimide varnish. As an organic solvent therefor, a solvent can be selected according to the intended use and processing conditions of the varnish. Examples of solvents that can be used include, but are not limited to, amide solvents such as N, N-dimethylformamide, N, N-dimethylacetamide, and N-methyl-2-pyrrolidone; ester solvents such as γ-butyrolactone, γ-valerolactone, δ-valerolactone, γ-caprolactone, ε-caprolactone, and x-methyl-Y-butyrolactone; carbonate solvents such as ethylene carbonate and propylene carbonate; glycol solvents such as diethylene glycol dimethyl ether, triethylene glycol, and triethylene glycol dimethyl ether; phenolic solvents such as phenol, m-cresol, p-cresol, o-cresol, 3-chlorophenol, and 4-chlorophenol; ketone solvents such as cyclopentanone, cyclohexanone, acetone, methyl ethyl ketone, diisobutyl ketone, and methyl isobutyl ketone; ether solvents such as tetrahydrofuran, 1,4-dioxane, dimethoxyethane, diethoxyethane, and dibutyl ether; and other general-purpose solvents such as acetophenone, 1,3-dimethyl-2-imidazolidinone, sulfolane, dimethylsulfoxide, butyl acetate, ethyl acetate, isobutyl acetate, propylene glycol methyl acetate, ethyl cellosolve, putyl cellosolve, 2-methyl cellosolve acetate, ethyl cellosolve acetate, butyl cellosolve acetate, chloroform, butanol, ethanol, xylene, toluene, chlorobenzene, turpentine, mineral spirits, and petroleum naphtha solvents. Of these, from the viewpoint of solubility, amide solvents such as N, N-dimethylformamide, N, N-dimethylacetamide, N-methyl-2-pyrrolidone; ester solvents such as γ-butyrolactone, γ-valerolactone, δ-valerolactone, γ-caprolactone, ε-caprolactone, and α-methyl-γ-butyrolactone; and carbonate solvents such as ethylene carbonate and propylene carbonate are preferably used. These solvents may be used as a mixture of two or more.

The solids concentration at the time when the polyimide contained in the material for melt processing according to the present invention is dissolved in a solvent to form a solution is preferably 5 wt % or more, while depending on the molecular weight of the polyimide, the production method, and the processed product to be produced. An excessively low solids concentration may result in difficulty in processing into a sufficient thickness, whereas a high solids concentration may result in difficulty in performing processing because of an excessively high solution viscosity. The method of dissolving the polyimide contained in the material for melt processing according to the present invention in a solvent is, for example, as follows: while the solvent is stirred, the polyimide powder contained in the material for melt processing according to the present invention is added and dissolved in air or an inert gas in a temperature range from room temperature to the boiling point of the solvent over 1 hour to 48 hours, whereby a polyimide solution (varnish) can be formed.

The polyimide solution obtained can be processed into various shapes by known methods. For example, when processed into a film, which is one of the forms of the material for melt processing according to the present invention, the polyimide solution is cast on a support such as a glass substrate using a doctor blade or the like and dried using a hot-air dryer, an infrared drying furnace, a vacuum dryer, an inert oven, or the like typically in the range of 40° C. to 350° C., preferably in the range of 50° C. to 250° C., whereby the film can be formed.

The melt processing in the present invention means processing in a broad sense relating to thermal melting including, for example, processing by commonly known melt molding methods, namely, not only injection molding, extrusion molding, hollow molding, compression molding, rotational molding, blow molding, calender molding, melt spinning molding, foam molding, and the like, but also fused deposition modeling, selective laser sintering, and the like, and fusion bonding or welding to, for example, a different resin material or a metal material.

The material for melt processing according to the present invention means a material that can be subjected to the above melt processing and used to produce the polyimide-containing melt-processed product according to the present invention.

In one embodiment, the material for melt processing in the present invention may contain only the polyimide having a repeating unit represented by general formula (1) above without containing other components. In another embodiment, the material for melt processing in the present invention may contain other optional components (e.g., other known thermoplastic resin materials, additives, colorants, and fillers) for various purposes. For example, the polyimide resin material may contain high-density polyethylene, medium-density polyethylene, isotactic polypropylene, polycarbonate, polyarylate, aliphatic polyamide, aromatic polyamide, polyamide-imide, polysulfone, polyethersulfone, polyether ketone, polyphenylene sulfide, polyether imide, polyester imide, modified polyphenylene oxide, hydrophilic agents, antioxidants, secondary antioxidants, lubricants, release agents, antifogging agents, weathering stabilizers, light stabilizers, UV absorbers, antistatic agents, metal deactivators, dyes, pigments, various powder metals, silver nanowires, carbon fibers, glass fibers, carbon nanotubes, graphene, ceramic materials such as calcium carbonate, titanium oxide, and silica, and the like. These can be incorporated in appropriate amounts depending on the intended use.

The shape of the material for melt processing according to the present invention is not particularly limited as long as it is suitable for producing the polyimide-containing melt-processed product according to the present invention, and may be, for example, powder-like, particle-like, chip-like, fiber-like, pellet-like, film-like, or tape-like.

The polyimide-containing melt-processed product in the present invention is not particularly limited as long as it is an article obtained by any of the above melt-processing methods, and examples include films, lenses, tapes, various electrical and electronic components such as laminates (e.g., copper-clad laminates) and flexible printed circuits (FPCs), sealants for electronic components, automotive parts, laminated materials, adhesives, prepregs, and three-dimensional objects.

### EXAMPLES

The present invention will now be described more specifically with reference to Examples, but it should be noted that the present invention is not limited to these Examples.

Analysis methods in the present invention are as follows.

### <Analysis Methods>

(1) Glass transition temperature (Tg) and thermoplasticity A polyimide film obtained was measured using the following apparatus under the following conditions, and a glass transition temperature (Tg) was calculated as an extrapolated point from a TMA curve. Thermoplasticity was evaluated from the steepness of a displacement of the TMA curve.

Apparatus: TMA7100 manufactured by Hitachi High-Tech Corporation

Sample size: width, 5 mm; length, 15 mm

Conditions: load, 20 mN; temperature range, 30° C. to 350° C.; heating rate, 5° C./min

Measurement mode: tensile

### (2) Dynamic Viscoelasticity

A polyimide film obtained was measured for storage modulus and loss modulus using the following apparatus 1 or 2 under the following conditions and evaluated for dynamic viscoelasticity.

Apparatus 1: DMA Q800 manufactured by TA Instruments Japan Inc.

Apparatus 2: DMA 850 manufactured by TA Instruments Japan Inc.

Conditions: frequency, 0.1 Hz; temperature range, 30° C. to 350° C.; heating rate, 3° C./min; amplitude, 0.1%

<Example 1>: Method for producing film-like material for melt processing containing polyimide (d) having following repeating unit

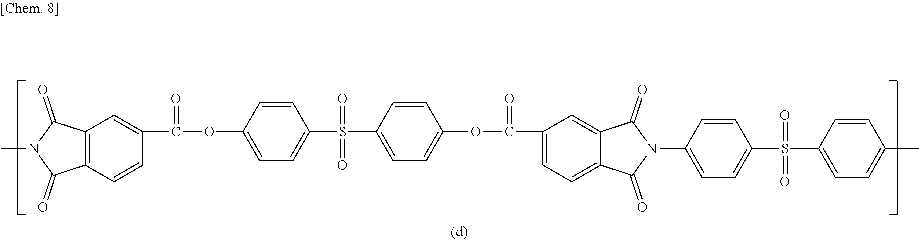

In a 100 mL screw vial, 1.9862 g of 4,4′-diaminodiphenylsulfone (b) and 27.0957 g of dimethylacetamide were added and allowed to dissolve at room temperature. Subsequently, 4.7885 g of 4,4′-dihydroxydiphenylsulfone-bis (trimellitate anhydride) (a) was added to the completely dissolved diamine solution. The resulting solution was stirred in a nitrogen atmosphere, and the stirring was stopped when the viscosity of the solution became sufficiently high, whereby a polyamic acid solution (c) having a resin content of 20 wt % and a reduced viscosity of 0.48 dl/g (40° C., 0.5 wt %) was obtained.

The polyamic acid (c) was cast on a flat glass plate serving as a support, and after the solvent was removed at 60° C. under a stream of nitrogen over 2 hours, the temperature was raised stepwise to 320° C. to perform imidization.

The film subjected to imidization was immersed in water, peeled off, and then dried at 250° C. and 0.1 kPa for 1 hour, whereby a film-like material for melt processing containing a polyimide (d) having the repeating unit above was obtained. The polyimide film obtained had a glass transition temperature (Tg) of 298° C. The film did not break when bent by 180° and was confirmed to be flexible and tough. The steepness of a displacement of a TMA curve confirmed for the first time that the polyimide represented by formula (d) above had thermoplasticity.

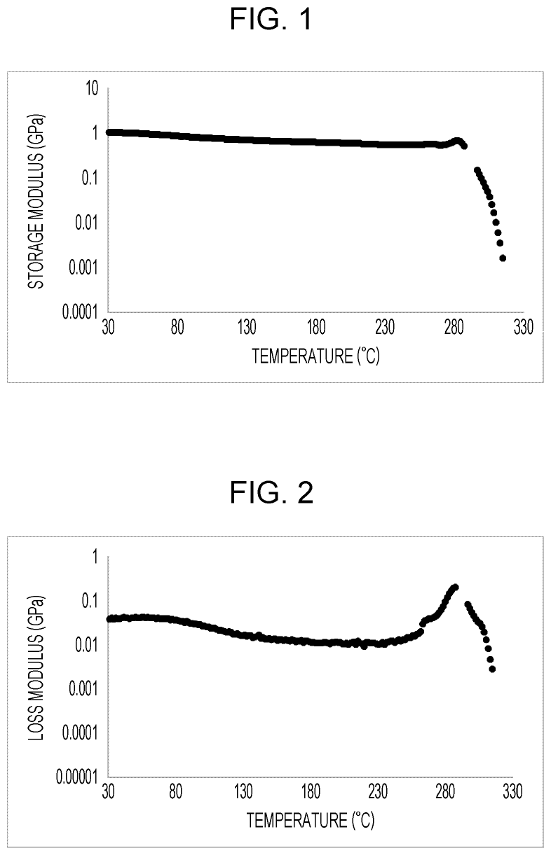

The storage modulus curve, the loss modulus curve, and the TMA curve of the polyimide film obtained are shown in FIGS. 1, 2, and 3, respectively.

<Comparative Example 1>: Method for producing polyimide (e) having following repeating unit

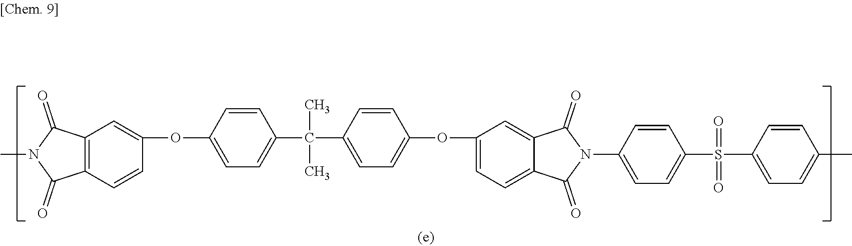

In a 100 mL screw vial, 1.9867 g of 4,4′-diaminodiphenylsulfone (b) and 14.3639 g of dimethylacetamide were added and allowed to dissolve at room temperature. Subsequently, 4.1639 g of 4,4′-(4,4′-isopropylidenediphenoxy)-bis (phthalic anhydride) was added to the completely dissolved diamine solution. The resulting solution was stirred in a nitrogen atmosphere, and the stirring was stopped when the viscosity of the solution became sufficiently high, whereby a polyamic acid solution having a resin content of 30 wt % and a reduced viscosity of 0.53 dl/g (40° C., 0.5 wt %) was obtained.

The polyamic acid obtained was cast on a flat glass plate serving as a support, and after the solvent was removed at 60° C. under a stream of nitrogen over 2 hours, the temperature was raised stepwise to 320° C. to perform imidization.

The film subjected to imidization was immersed in water, peeled off, and then dried at 250° C. and 0.1 kPa for 1 hour. The polyimide film obtained had a glass transition temperature (Tg) of 253° C.

The storage modulus curve, the loss modulus curve, and the TMA curve of the polyimide film obtained are shown in FIGS. 4, 5, and 6, respectively.

For the polyimide of Example 1, film softening is observed at around 300° C., which is the glass transition temperature (Tg) of the polyimide, and as shown in FIGS. 1 and 2, the storage modulus curve and the loss modulus curve have very steep descending slopes, thus revealing for the first time that the polyimide is a highly heat-resistant thermoplastic resin.

By contrast, for the polyimide of Comparative Example 1, film softening is observed at around 250° C., which is the glass transition temperature (Tg) of the polyimide, and as shown in FIGS. 4 and 5, descending slopes of the storage modulus curve and the loss modulus curve have confirmed that the polyimide is a thermoplastic resin.

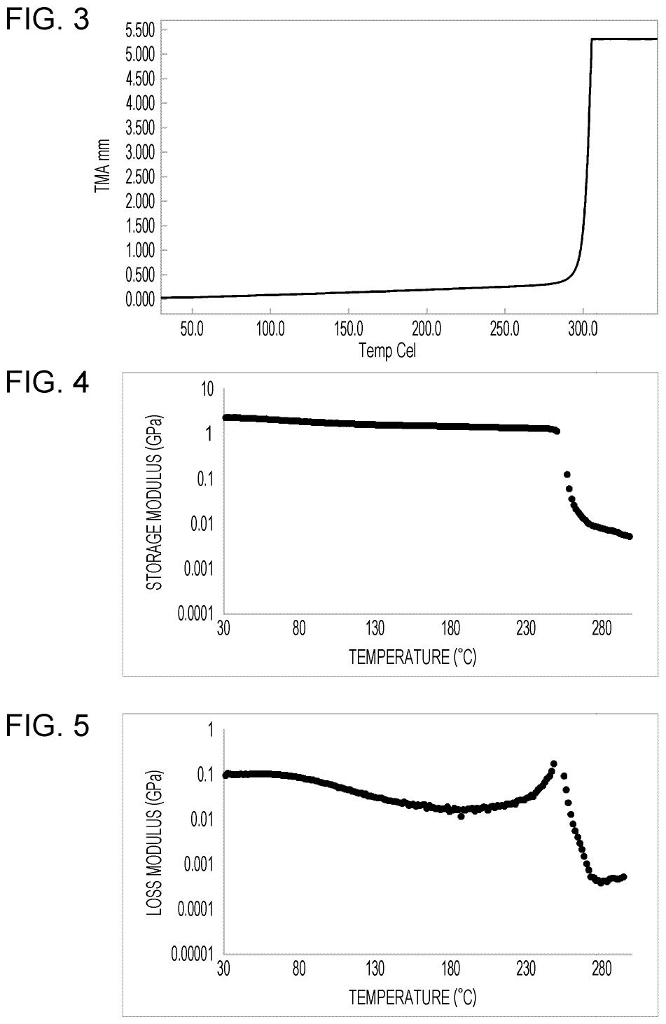

Looking at the storage modulus curve and the loss modulus curve from the viewpoint of melt processability, it is observed that both of the curves of the polyimide of Example 1 keep descending after 300° C., which is the glass transition temperature (Tg) of the polyimide. This indicates that during melt processing, elasticity and viscosity among the polymer properties rapidly decrease even at around 300° C. slightly higher than the glass transition temperature (Tg), resulting in a good flow state. In addition, as shown in FIG. 3, it has become clear from the TMA curve that a steep displacement occurs at around 300° C., which is the glass transition temperature (Tg). From the above, it has become clear that the polyimide of Example 1 is a thermoplastic polyimide resin having high heat resistance and also having high melt flowability.

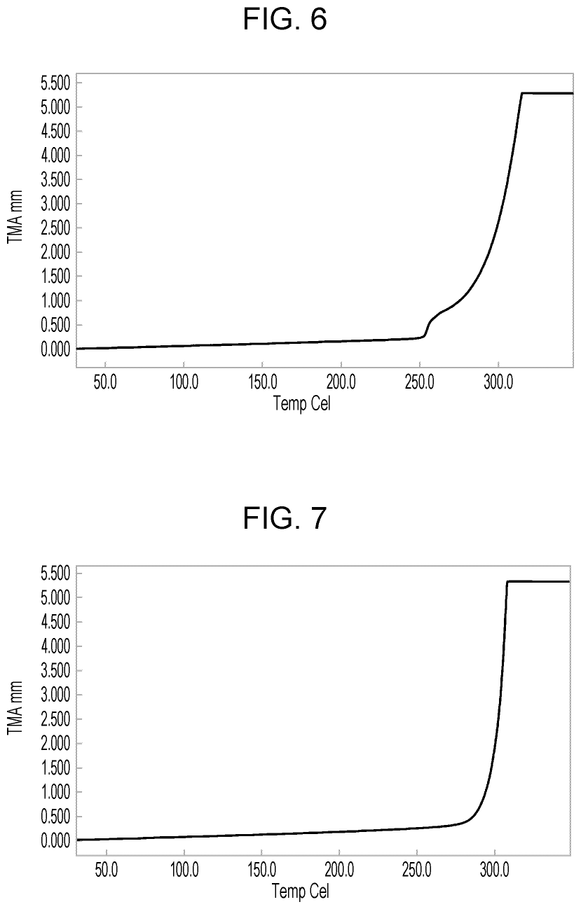

By contrast, for the polyimide of Comparative Example 1, the relaxation phenomenon is observed in both the storage modulus curve and the loss modulus curve descending after 250° C., which is the glass transition temperature (Tg) of the polyimide. This suggests that during melt processing, a melt processing temperature still higher than 250° C., which is the glass transition temperature (Tg) of the polyimide, is required in order to sufficiently decrease the elasticity and viscosity. Furthermore, as shown in FIG. 6, in the TMA curve, a displacement can be observed once at around 250° C., which is the glass transition temperature (Tg), but immediately thereafter, the ascending slope of the displacement curve becomes gradual. This, together with the relaxation phenomenon that can be observed in the storage modulus curve and the loss modulus curve shown in FIGS. 4 and 5, indicates that the elasticity and viscosity do not sufficiently decrease and the melt processability is poor.

From the above results, it has become clear that the polyimide resin of Example 1, which is a specific example of the material for melt processing according to the present invention, is a polyimide resin that satisfies the trade-off relationship between high heat resistance and high melt flowability and can be used as a material for melt processing having high heat resistance and high melt processability.

### Example 2

A polyimide film was obtained in the same manner as in Example 1 except that 4,4′-diaminodiphenylsulfone was replaced with 4,4′-diaminodiphenyl ether.

The polyimide film obtained had a glass transition temperature (Tg) of 272° C. The film did not break when bent by 180° and was confirmed to be flexible and tough. The steepness of a displacement of a TMA curve confirmed that the film had thermoplasticity and high melt flowability.

The TMA curve of the polyimide film obtained is shown in FIG. 7.

### Example 3

A polyimide film was obtained in the same manner as in Example 1 except that 4,4′-diaminodiphenylsulfone was replaced with 2, 2′-bis (trifluoromethyl) benzidine.

The polyimide film obtained had a glass transition temperature (Tg) of 284° C. The film did not break when bent by 180° and was confirmed to be flexible and tough. The steepness of a displacement of a TMA curve confirmed that the film had thermoplasticity and high melt flowability.

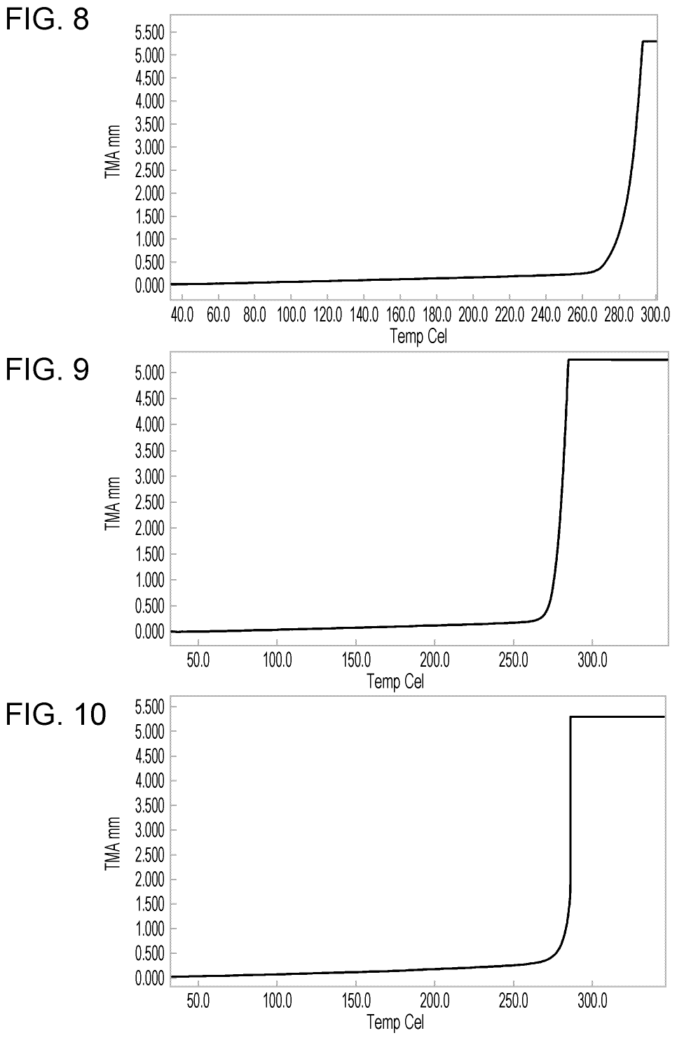

The TMA curve of the polyimide film obtained is shown in FIG. 8.

### Example 4

A polyimide film was obtained in the same manner as in Example 1 except that 4,4′-diaminodiphenylsulfone was replaced with m-phenylenediamine.

The polyimide film obtained had a glass transition temperature (Tg) of 273° C. The film did not break when bent by 180° and was confirmed to be flexible and tough. The steepness of a displacement of a TMA curve confirmed that the film had thermoplasticity and high melt flowability.

The TMA curve of the polyimide film obtained is shown in FIG. 9.

### Example 5

A polyimide film was obtained in the same manner as in Example 1 except that 4,4′-diaminodiphenylsulfone was replaced with a 1:1 mixture of p-phenylenediamine and m-phenylenediamine.

The polyimide film obtained had a glass transition temperature (Tg) of 286° C. The film did not break when bent by 180° and was confirmed to be flexible and tough. The steepness of a displacement of a TMA curve confirmed that the film had thermoplasticity and high melt flowability.

The TMA curve of the polyimide film obtained is shown in FIG. 10.

The results of Examples 2 to 5 have revealed that as with the polyimide of Example 1, the polyimides of Examples 2 to 5 are also polyimide resins having high heat resistance and high melt flowability and can be used as materials for melt processing having high heat resistance and high melt processability.

### Comparative Example 2

A polyimide film was obtained in the same manner as in Example 1 except that 4,4′-diaminodiphenylsulfone was replaced with 2, 2′-bis [4-(4-aminophenoxy) phenyl) propane.

The polyimide film obtained had a glass transition temperature (Tg) of 241° C.

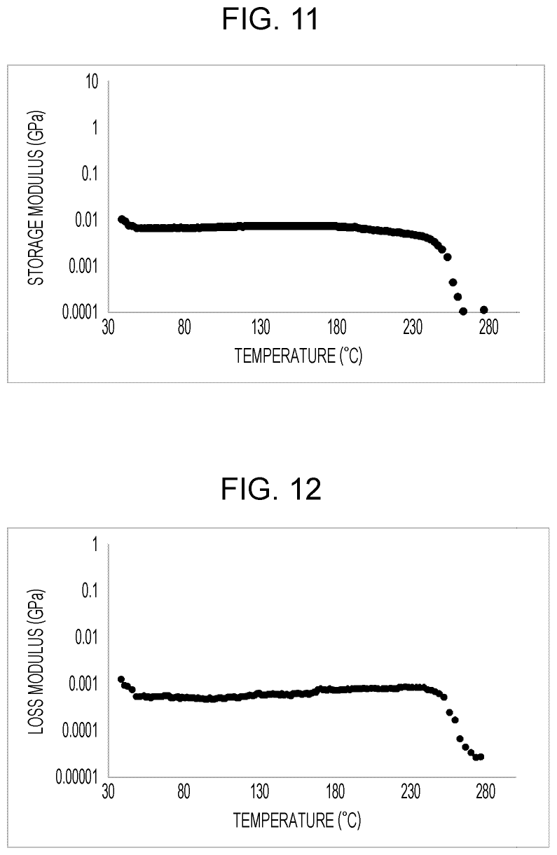

The storage modulus curve, the loss modulus curve, and the TMA curve of the polyimide film obtained are shown in FIGS. 11, 12, and 13, respectively.

For the polyimide of Comparative Example 2, as in Comparative Example 1, the relaxation phenomenon is observed in both the storage modulus curve and the loss modulus curve descending after 240° C., which is the glass transition temperature (Tg) of the polyimide. This indicates that during melt processing, a melt processing temperature still higher than 240° C., which is the glass transition temperature (Tg) of the polyimide, is required in order to sufficiently decrease the elasticity and viscosity.

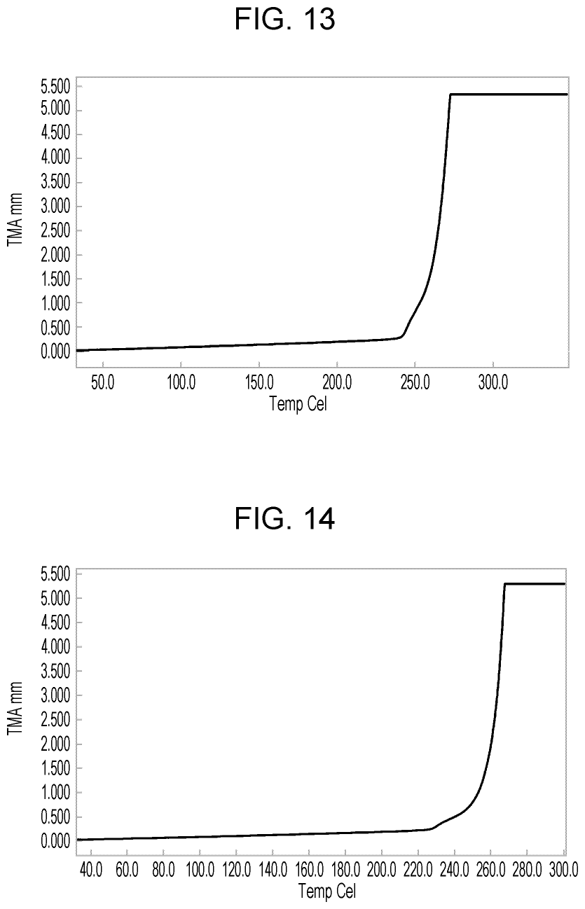

Furthermore, in the TMA curve shown in FIG. 13, a displacement can be observed at around 240° C., which is the glass transition temperature (Tg), but the slope of the rise of the displacement curve is small. This also indicates that the melt processability is poor as in Comparative Example 1.

### Comparative Example 3

A polyimide film was obtained in the same manner as in Example 1 except that 4,4′-diaminodiphenylsulfone was replaced with 1,3-bis (4-aminophenoxy) benzene.

The polyimide film obtained had a glass transition temperature (Tg) of 226° C.

The TMA curve of the polyimide film obtained is shown in FIG. 14. In the TMA curve shown in FIG. 14, a displacement can be observed at around 230° C., which is the glass transition temperature (Tg), but the slope of the rise of the displacement curve is small. This indicates the melt processability is poor as in Comparative Example 1.

1. A material for melt processing, comprising a polyimide having a repeating unit represented by general formula (1) below, 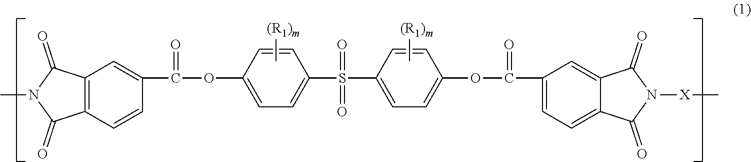
where each R₁ independently represents a linear or branched alkyl group having 1 to 6 carbon atoms, a linear or branched alkyl halide group having 1 to 6 carbon atoms, or a halogen atom, each m independently represents 0, 1, or 2, and X represents a divalent chemical group represented by general formula (2) below, 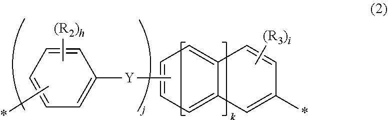
where R₂ and R₃ each independently represent a linear or branched alkyl group having 1 to 6 carbon atoms, a linear or branched alkyl halide group having 1 to 6 carbon atoms, or a halogen atom, Y represents a direct bond, an oxygen atom, a sulfur atom, a sulfonyl group (—SO₂—), a carbonyl group (—CO—), an amide group (—NHCO—), an ester group (—OCO—), an alkylidene group having 1 to 15 carbon atoms, a fluorine-containing alkylidene group having 2 to 15 carbon atoms, a cycloalkylidene group having 5 to 15 carbon atoms, a phenylmethylidene group, a phenylethylidene group, a phenylene group, or a fluorenylidene group, j represents 0 or 1, h and i each independently represent 0, 1, or 2, k represents 0, 1, or 2, and each * represents a position of bonding to a nitrogen atom in general formula (1).

2. A melt-processed product obtained by performing melt processing using the material for melt processing according to claim 1.
